(19) United States
(12) Patent Application Publication
(10) Pub. No.: US 2006/0082912 A1
(43) Pub. Date: Apr. 20, 2006

(54) Cleaning read/write heads of a magnetic tape recording system

(76) Inventors: John Mark MacKelden, Wiltshire (GB); Nigel Ronald Evans, Bristol (GB); Stephen V. Deckers, Eagle, ID (US)

Correspondence Address: HEWLETT-PACKARD COMPANY;Intellectual Property Administration, P. O. Box 272400, Fort Collins, CO, 80527-2400, US

(21) Appl. No.: 10/965,196

(22) Filed: Oct. 15, 2004

(51) Int. Cl. G11B 27/36; G11B 5/09; G11B 5/41; G11B 19/02

(52) U.S. Cl. 360/31; 360/53; 360/69; 360/128

(57) ABSTRACT

A method is provided of cleaning one or more read/write heads of a magnetic tape recording system using a magnetically recordable cleaning tape in the system. The system performs a cleaning operation including pulling a portion of the cleaning tape through the system so as to clean the or each head. A log is recorded on the cleaning tape of the sequence of operations so as to provide a history of usage of the cleaning tape.

### FIELD OF THE INVENTION

The present invention relates to cleaning one or more read/write heads of a magnetic tape recording system using a cleaning tape.

### BACKGROUND OF THE INVENTION

A common form of storage medium for use in storing computer data takes the form of a magnetically recordable tape that is moved relative to magnetic read/write heads. One form of magnetic tape data recording system comprises a helical-scan tape deck in which the tape from a tape cartridge passes at a predetermined angle across a rotary head drum. In operation the tape is drawn from a supply reel to a take-up reel by rotation of a capstan against which the tape is pressed by a pinch roller. The head drum houses two write heads angularly spaced by 180° and two read heads also angularly spaced by 180°.

The magnetic tape is subject to wear and deterioration and the recording system is subject to head clogs. The result is that errors occur in the read/write process. Whilst some errors can be corrected by a format of data encoding that includes error correction within the format definition, nevertheless it is necessary to take steps to clean the read/write heads so that errors that are attributable to dirty heads are eliminated or reduced.

It is already known to clean the magnetic read/write heads by inserting a cleaning tape cartridge into such a magnetic data recording system. The cleaning tape cartridge contains a cleaning tape that has no recorded data but is pulled through the data recording system to clean the heads. The cleaning tape is advanced by a chosen increment to clean the heads. The increment of cleaning tape that is pulled through the data recording system is contaminated by the cleaning process and cannot be re-used. A fresh increment of the cleaning tape must be advanced when a cleaning operation is performed the next time.

A disadvantage of the conventional method of cleaning the heads of the data recording system by a cleaning tape is that there is no indication of how effective the cleaning operation has been until a data recording tape has been inserted into the system and data recording has been undertaken. This may result in the situation where an unsatisfactory cleaning operation has resulted and the cleaning operation has to be repeated all over again. Alternatively, the length of cleaning tape that is incremented to clean the heads is deliberately chosen to be longer than necessary for a successful cleaning operation in an attempt to ensure the success of the cleaning operation. This may result in wastage of the cleaning tape.

It has already been proposed in U.S. Pat. No. 5,381,292 to clean a section of a magnetic tape where read/write errors occur. In a first step, the tape is spooled to one end of the tape at 300 times the normal read or write speed. In a second step, the tape is spooled to the other end of the tape at 300 times the normal read or write speed. In the third step, the tape is moved to place the heads over the section where the errors occurred.

It has also been proposed in published U.S. patent application 20030169529 to use a cleaning cartridge in a magnetic recording system, the cleaning tape having a pattern signal recorded on a predetermined segment that is read by a magnetic head in the system. On-site adjustments can be made to parameters of the magnetic head by reading the pattern from the cleaning tape when the user directs a cleaning operation. A failure of the magnetic head can also be detected and predicted through the cleaning operation.

### SUMMARY OF THE INVENTION

According to the present invention, there is now provided a method of cleaning one or more read/write heads of a magnetic tape recording system, the method comprising;

setting a magnetically recordable cleaning tape in the system,

instructing the system to perform a sequence of operations including pulling a portion of the cleaning tape through the system so as to clean the or each head, and

recording on the cleaning tape a log of the said sequence of operations providing a history of usage of the cleaning tape.

Further, according to the present invention, there is provided a magnetic recording system having one or more read/write heads and adapted to receive a magnetically recordable cleaning tape;

the system being programmed;

to perform a sequence of operations that includes pulling a portion of the cleaning tape through the system so as to clean the or each head, and

to record on the cleaning tape a log of the said sequence of operations providing a history of usage of the cleaning tape.

### DESCRIPTION OF THE DRAWINGS

The invention will now be described, by way of example only, by reference to the accompanying drawings in which;

FIG. 1 shows a block diagram of the components of a magnetic tape recording system embodying the present invention;

FIG. 2 shows the main physical components of a tape deck included in the system of FIG. 1,

FIG. 3 is a diagrammatic representation of two data tracks recorded on a tape by means of the tape deck of FIG. 2,

FIG. 4 is a flow diagram of steps used in the method of the present invention,

FIG. 5 is a diagrammatic representation of a cleaning tape including a tape log updated in accordance with the method of FIG. 4, and

FIGS. 6 and 7 are flow diagrams of further steps used in the method of the present invention.

### DETAILED DESCRIPTION OF THE INVENTION

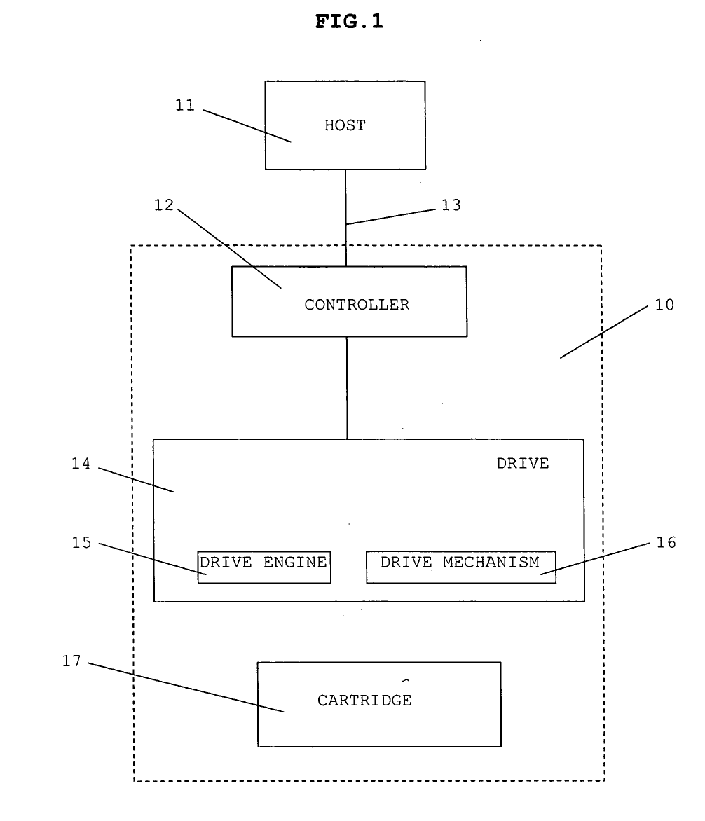

Referring to FIG. 1, there is shown a data storage system 10 embodying the present invention. The system includes a host 11 coupled to a controller 12 via an interface 13. The controller 12 is programmed to control a tape drive 14 that includes a drive engine 15 and a drive mechanism 16. The drive mechanism is adapted to receive a tape cartridge 17. A controlling software application on the host 11 controls the reading and writing of data on a magnetic data tape in the tape cartridge 17.

The host system 11 has at least one central processing unit (CPU) and a memory to store the controlling software application. The interface 13 connecting the host system 11 to the controller 12 may be any suitable proprietary standard bus known to those skilled in the art.

The drive mechanism 16 includes electrical and mechanical components that receive, position and access tape cartridges. The drive mechanism has components to lock a tape cartridge in place, an ejection motor and read/write heads. The drive engine 15 is a data processor that is programmed to supervise the operations of the drive mechanism 16 and to manage the flow of data to be recorded in or read from a tape cartridge 17 received in the drive 14. A cleaning cartridge that stores a cleaning tape may be loaded in the drive 14 to effect cleaning of the read/write heads. The drive engine 15 has a program to control the process of cleaning the read/write heads by means of the cleaning tape as will be explained in greater detail below. The drive engine 15 is programmed to calculate and register the error rate of data that is recorded on a tape cartridge that is loaded in the drive 14.

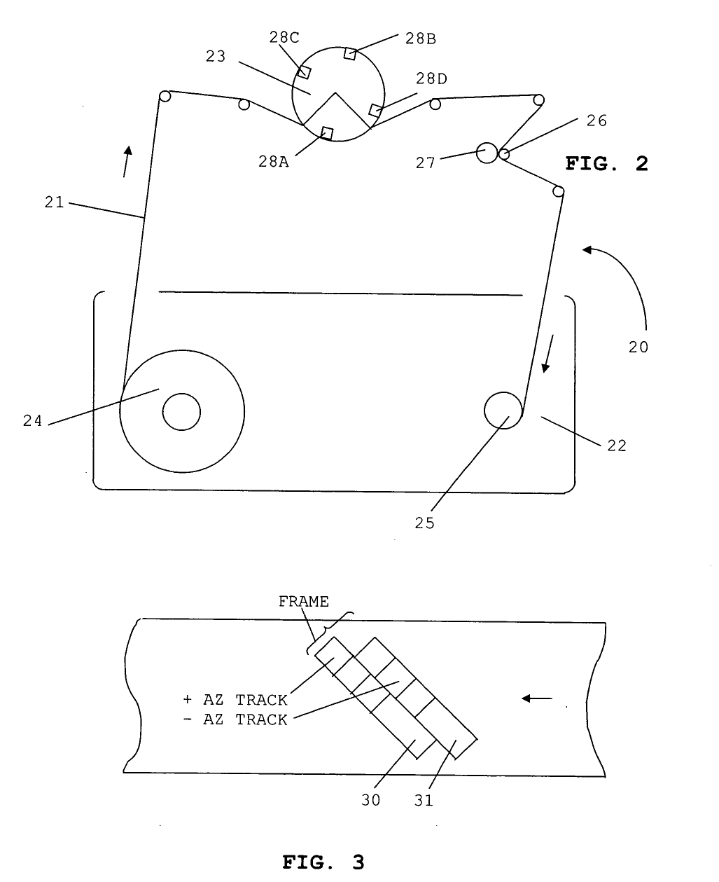

Referring to FIG. 2, there is shown the basic layout of the tape drive 14 which is in the form of a helical-scan tape deck 20 in which tape 21 from a tape cartridge 22 passes at an angle across a rotary head drum 23. The tape is driven in the direction indicated by the arrows from a motor driven supply reel 24 to a motor driven take up reel 25. A capstan 26 and pinch roller 27 control the passage of the tape past the head drum 23. The rotary head drum 23 carries two magnetic write heads 28A and 28B spaced apart by 180° and two magnetic read heads 28C and 28D also spaced apart by 180°. The heads 28A and 28B are arranged to write a succession of overlapping oblique data tracks 30, 31 on the tape as shown in FIG. 3. The two tracks 30, 31 are representative of a succession of tracks along the tape that are recorded in a manner well known in the art. The track written by the head 28A has a positive azimuth while the track written by the head 28B has a negative azimuth. Each pair of positive and negative azimuth tracks 30,31 constitutes a frame.

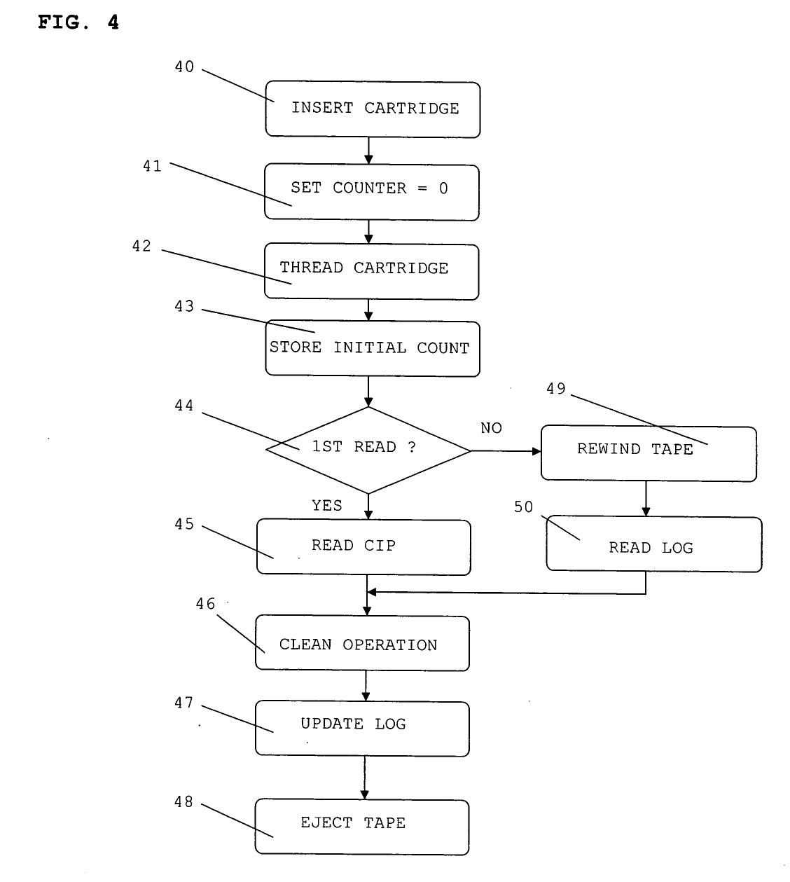

FIG. 4 shows a sequence of steps that is taken to clean the heads 28A, 28B, 28C and 28D by means of a cleaning tape. The cleaning tape is a magnetically recordable tape on which the heads 28A and 28B can record data in the manner already described and illustrated in FIGS. 2 and 3. FIG. 5 is a diagrammatic representation of the cleaning tape 51 that has an initial tape area 51a in which a cartridge identifier pattern (CIP) is recorded. The cleaning tape 51 also includes tape portions 52, 53, 54 and 55 that are referred to as clean 1, clean 2, clean 3 and extension. Areas 56 of the tape 51 are situated at the end of each of the tape portions 52, 53 and 55 to record a log for a purpose that will be explained.

Referring again to FIG. 4, in step 40, the cleaning cartridge including the cleaning tape 51 is loaded in the tape drive 14. A counter in the controller 12 is set to zero in step 41 to indicate that this is a preparatory phase of a cleaning operation. In step 42, the cleaning tape 51 in the cleaning cartridge is threaded through the tape drive 14. In step 43, the initial count is stored in the controller 12. In step 44 a determination is made whether this is the first use of the cleaning tape and, if so, in step 45 the read heads 28C and 28D read the cartridge identifier pattern (CIP) recorded in the initial tape area 51a at the beginning of the tape. In step 46 the cleaning tape is incrementally advanced and cleaning of the heads 28A, 28B, 28C and 28D is initiated by backwards and forwards motion of the tape using the tape portion 52 of the cleaning tape 51. After the cleaning operation in step 46 is completed, the write heads 28A and 28B are used in step 47 to record a sequence of data constituting a log in the first of the areas 56 following the tape portion 52 on the cleaning tape. On completion of the data recording step 47, the tape is ejected in step 48 with the tape 51 left in the finishing position at the end of the log data recorded in the first area 56.

On the next load of the cleaning cartridge, the determination in the step 44 will indicate that this is not the first load of the cartridge. In this case, the process continues to the step 49 where the tape drive rewinds the tape 51 from its prior finishing position so that the read heads 28C and 28D are positioned to read the log recorded in the first of the areas 56. The placement of the tape 51 in position to enable the log to be read is shown diagrammatically by the arrow 57 in FIG. 5. The tape 51 is then moved forward in the step 50 to enable the log to be read and its data content to be stored by the tape drive. The process then continues to the step 47 in which the cleaning tape is incrementally advanced and cleaning of the heads 28A, 28B, 28C and 28D is initiated by backwards and forwards motion of the tape using the tape portion 53 of the cleaning tape 51. After the cleaning operation in step 46 is completed, the write heads 28A and 28B are used in step 47 to record in the second of the tape areas 56 an update of the data in the log. On completion of the data recording step 47, the tape is ejected in step 48 with the tape 51 left in the finishing position at the end of the data recorded in the updated log.

If the cleaning tape cartridge is loaded for a third time, the determination in the step 44 will again indicate that this is not the first load of the cartridge. As before, the process continues to the step 49 where the tape drive rewinds the tape 51 from its prior finishing position so that the read heads 28C and 28D are positioned to read the updated log at the end of the tape portion 53. The placement of the tape 51 in position to enable the log to be read is shown diagrammatically by the arrow 58 in FIG. 5. The tape 51 is then moved forward in the step 50 to enable the log on the tape 51 to be read again and its data content to be stored by the tape drive.

The process continues to the cleaning step 46 as before. The process of cleaning will, in this case, use the tape portion 54 of the cleaning tape 51. If, however, the cleaning operation is unsatisfactory using any of the tape portions, an extended cleaning operation is conducted using an extended portion of the tape 51. Thus, assuming the cleaning operation using the tape portion 54 is unsatisfactory, an extended cleaning operation is effected using the extended cleaning portion 55. Following the extended cleaning operation, the write heads 28A and 28B are used in step 47 to record an update of the sequence of data in the log using the tape area 56 at the end of the extended tape portion 55.

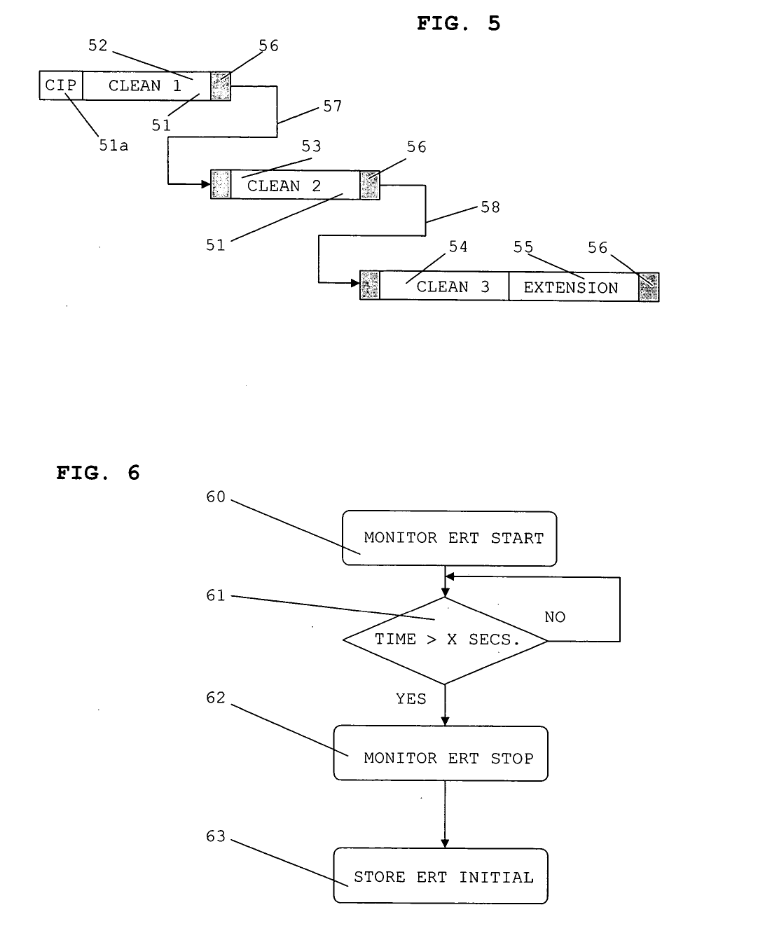

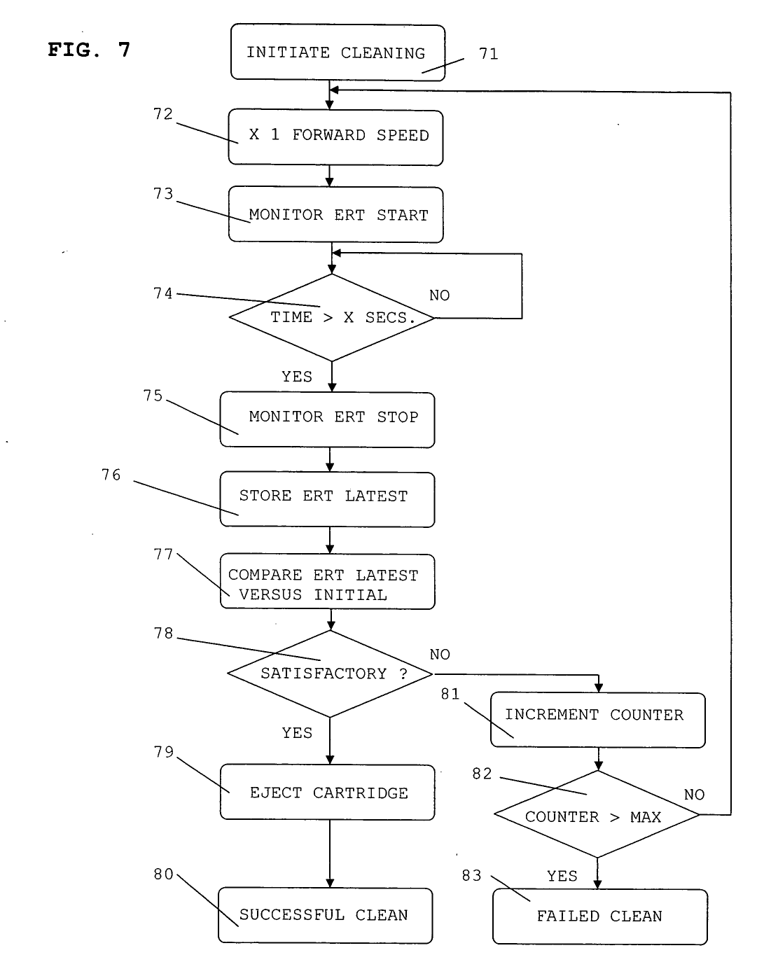

The method of determining whether a cleaning operation is unsatisfactory or not, and therefore whether an extended cleaning operation is required, will be described with reference to FIGS. 6 and 7. In general terms, the method illustrated in FIGS. 6 and 7 comprises recording test data onto the cleaning tape 51 by means of the write heads 28A and 28B as each cleaning portion of the tape is being pulled through the system and performing a read-while-write check on the test data. The error rate of the test data is calculated and the system is instructed to perform another cleaning operation if the calculated error rate is above a target error rate.

Referring to FIG. 6, in step 60 the test data is recorded in an initial section of the tape 51 so that an initial error rate for the recording system can be determined from the test data and registered by means of the drive engine 15. In step 61, the start time of the error rate test (ERT) is monitored. A check is performed in step 62 to determine whether the cleaning tape has been incremented for a time up to the end of a fixed test interval of X seconds. The initial error rate of the recorded test data is determined in step 62 and stored in step 63 by means of the drive engine 15.

Referring now to FIG. 7, in step 71, cleaning of the heads 28A, 28B, 28C and 28D is initiated by backwards and forwards motion of the tape 51 after the initial error rate has been derived and registered by means of the sequence of steps shown in FIG. 6. As will be described, the initial error rate is used as a reference from which to determine the degree of success achieved in cleaning the heads.

In step 72 the cleaning tape is advanced at the normal recording speed, clearing the previously recorded area on the tape, so that the tape portion 52 of cleaning tape is presented to the heads 28A, 28B, 28C and 28D. The heads 28A and 28B again record a sequence of test data on the cleaning tape. In step 73, the start time of an error rate test is monitored. A check is performed in step 74 to determine whether the cleaning tape has been incremented for a time up to the end of the fixed test interval of X seconds. The error rate of the recorded test data is determined in step 75 and stored in step 76 by means of the drive engine 15.

In step 77, the error rate stored in step 76 is compared with the initial error rate to determine the extent to which the error rate has improved as a result of the cleaning operation. A value representing that improvement by reference to the initial error rate is generated in the step 77. A check is made in step 78 to determine if the value generated in the step 77 represents a drop in the error rate down to a target value that is referenced to the initial error rate. If so, the cleaning cartridge is ejected from the drive 14 in step 79. An indication of a successful cleaning operation is provided in step 80 to an operator of the system 10.

If the check performed in the step 78 shows that the drop in the error rate has not reached the target value, the process continues to a step 81 where the counter initially set to zero in step 41 of FIG. 4 is incremented by one. The process then continues to step 82 where a check is made on the number to which the counter has been incremented. If the counter has been incremented to a value less than a maximum pre-set value, the process returns to the step 72 and the cleaning cartridge is advanced once again to perform a new cleaning operation. The new cleaning operation may be a repeat of the previous cleaning operation including the same sequence of steps as the previous operation. Alternatively, the new cleaning operation may be a modified cleaning operation in which, for example, a greater length of cleaning tape is advanced to perform the new cleaning operation. In yet another alternative, the new cleaning operation may involve a greater number of backwards and forwards motions of the cleaning tape.

If the check performed in the step 82 shows that the counter has been incremented to its maximum value, the process moves on to the step 83. In the step 83, an error flag is set to indicate a failed cleaning operation. This flag can be read by the host 11, if desired, whereby the host will be informed that the clean attempt has failed.

In an alternative embodiment of the invention, the check carried out in step 78 may be a check to determine if the error rate calculated in step 77 is below a fixed predetermined target value for the error rate. In this case the target value is not referenced to an initial value of error rate but is an absolute value. In this case also, the steps 60 to 63 may be dispensed with since an initial value of error rate is not required.

The current data in the tape log is registered within the tape drive preparatory to each cleaning operation. As described above, after a cleaning operation, the log data is updated and rewritten to the next tape area 56. The data itself includes the cartridge identifier pattern (CIP) representing the manufacturer of the cleaning tape cartridge, a serial number of the tape 51, and diagnostic information. The diagnostic information includes cumulative information on the history of usage of the cleaning tape 51 and comprises a history of the number of times the tape 51 has been used for cleaning, data on the number of times the calculated error rate is above the target error rate (i.e. the number of times an extended cleaning operation has been necessary), an identification by means of a serial number of each of the tape drives that have been cleaned and a flag indicating if the cleaning cartridge is faulty or has expired within a date recorded on the cartridge. The log is useful in tracking the performance of different cleaning cartridges so as to build up usage models of behaviour that can be used to support recommendations to end users of cleaning tape cartridges. The recommendations can be made with reference to the serial numbers of the cleaning tape cartridges and the tape drives that are cleaned by the tape cartridges.

What has been described is a method of cleaning the read/write heads of a magnetic tape data recording system by means of a magnetically recordable cleaning tape in which the system is instructed to perform a sequence of operations including pulling a portion of the cleaning tape through the system so as to clean the heads, and to record on the cleaning tape a log of the sequence of operations. The log provides a history of usage of the cleaning tape.

In providing the history of usage, the log may be recorded to indicate the number of times the calculated error rate is above the target error rate, to identify the magnetic tape recording system and to record whether a pre-recorded date associated with the tape has expired. The log may be recorded to provide a history of the number of cleaning operations in which the cleaning tape has been used and to provide a history of the number of times an increased length of the cleaning tape is employed.

While the invention has been described in relation to a magnetic tape drive which is in the form of a helical-scan tape deck in which tape from a tape cartridge passes at an angle across a rotary head drum, the invention may also be applied to other forms of magnetic tape recording system including, for example, a magnetic tape cartridge system such as the Linear-Tape-Open (LTO) system.

Furthermore, while the drive engine 15 has been described as having a program to control the process of cleaning the read/write heads by means of the cleaning tape and recording a log of data on a tape cartridge that is loaded in the drive, the drive engine 15 may alternatively be programmed by the incorporation of a suitably constructed application specific integrated circuit (ASIC) into the drive engine 15.

1. A method of cleaning one or more read/write heads of a magnetic tape recording system, the method comprising;
setting a magnetically recordable cleaning tape in the system,
instructing the system to perform a sequence of operations including pulling a portion of the cleaning tape through the system so as to clean the or each head, and
recording on the cleaning tape a log of the said sequence of operations providing a history of usage of the cleaning tape.

2. A method as claimed in claim 1, comprising recording test data onto the cleaning tape by means of the or each head as the said portion of the tape is being pulled through the system and performing a read-while-write check on the test data to calculate the error rate of the test data, and
instructing the system to perform another cleaning operation if the calculated error rate is above a target error rate.

3. A method as claimed in claim 2, wherein the log is recorded to indicate the number of times the calculated error rate is above the target error rate.

4. A method as claimed in claim 1, wherein the log is recorded to identify the magnetic tape recording system.

5. A method as claimed in claim 1, wherein the log records whether a pre-recorded date associated with the tape has expired.

6. A method as claimed in claim 2, in which the step of instructing the system to perform another cleaning operation if the calculated error rate is above the target error rate comprises instructing the system to repeat the first said cleaning operation.

7. A method as claimed in claim 6, wherein the log is recorded to provide a history of the number of cleaning operations in which the cleaning tape has been used.

8. A method as claimed in claim 2, in which the step of instructing the system to perform another cleaning operation if the calculated error rate is above the target error rate comprises instructing the system to perform a modification of the first said cleaning operation.

9. A method as claimed in claim 8, in which the modification of the first said cleaning operation employs an increased length of the cleaning tape compared to the first said cleaning operation.

10. A method as claimed in claim 9, wherein the log is recorded to provide a history of the number of times an increased length of the cleaning tape is employed.

11. A method as claimed in claim 2, comprising the further step of pulling an initial portion of the tape through the system and calculating an initial error rate.

12. A method as claimed in claim 11, wherein the target error rate is a value referenced to the said initial error rate.

13. A method as claimed in claim 2, wherein the target error rate is a predetermined error rate.

14. A method as claimed in claim 2, wherein the system is instructed to perform cleaning operations until either the calculated error rate of the test data is below the target error rate or cleaning operations have been performed a predetermined number of times.

15. A magnetic recording system having one or more read/write heads and adapted to receive a magnetically recordable cleaning tape;
the system being programmed;
to perform a sequence of operations that includes pulling a portion of the cleaning tape through the system so as to clean the or each head, and
to record on the cleaning tape a log of the said sequence of operations providing a history of usage of the cleaning tape.

16. A system as claimed in claim 15, programmed to record test data onto the cleaning tape by means of the or each head as the said portion of the tape is pulled through the system and to perform a read-while-write check on the test data to calculate the error rate of the test data;
the system being further programmed to perform another cleaning operation if the calculated error rate is above a target error rate.

17. A system as claimed in claim 16, wherein the log is recorded to indicate the number of times the calculated error rate is above the target error rate.

18. A system as claimed in claim 15, wherein the log is recorded to identify the magnetic tape recording system.

19. A system as claimed in claim 15, wherein the log records whether a pre-recorded date associated with the tape has expired.

20. A system as claimed in claim 16, which is programmed to repeat the first said cleaning operation if the calculated error rate is above the target error rate.

21. A system as claimed in claim 20, wherein the log is recorded to provide a history of the number of cleaning operations in which the cleaning tape has been used.

22. A system as claimed in claim 16, which is programmed to perform a modification of the first said cleaning operation if the calculated error rate is above the target error rate.

23. A system as claimed in claim 22, in which the modification of the first said cleaning operation employs an increased length of the cleaning tape compared to the first said cleaning operation.

24. A system as claimed in claim 23, wherein the log is recorded to provide a history of the number of times an increased length of the cleaning tape is employed.

25. A system as claimed in claim 16, the system being further programmed to pull an initial portion of the tape through the system and to calculate an initial error rate.

26. A system as claimed in claim 25, wherein the target error rate is a value referenced to the said initial error rate.

27. A system as claimed in claim 16, wherein the target error rate is a predetermined error rate.

28. A system as claimed in claim 16, wherein the system is instructed to perform cleaning operations until either the calculated error rate of the test data is below the target error rate or a predetermined number of cleaning operations have been performed.

29. A computer program for controlling a magnetic recording system having one or more read/write heads and adapted to receive a magnetically recordable cleaning tape;
the program, when loaded in the system, being effective to cause the system;
to perform a cleaning operation that includes pulling a portion of the cleaning tape through the system so as to clean the or each head, and
to record on the cleaning tape a log of the said sequence of operations providing a history of usage of the cleaning tape.

30. A logic circuit constructed to control a magnetic recording system having one or more read/write heads, the magnetic recording system being adapted to receive a magnetically recordable cleaning tape;
the logic circuit, when incorporated into the system, being effective to cause the system;
to perform a cleaning operation that includes pulling a portion of the cleaning tape through the system so as to clean the or each head, and
to record on the cleaning tape a log of the said sequence of operations providing a history of usage of the cleaning tape.
